(19) United States
(12) Patent Application Publication
(10) Pub. No.: US 2020/0092786 A1
(43) Pub. Date: Mar. 19, 2020

(54) COMPENSATING FOR HIGH SPEED TRAVEL IN PACKET-BASED COMMUNICATIONS

(71) Applicant: QUALCOMM Incorporated, San Diego, CA (US)

(72) Inventors: Shankar Ganesh LAKSHMANASWAMY, Bangalore (IN); Manjunatha KANTHARAJU, Bangalore (IN); Min WANG, San Diego, CA (US); Tony LEE, San Diego, CA (US); JinXing WANG, Beijing (CN)

(21) Appl. No.: 16/133,392

(22) Filed: Sep. 17, 2018

(51) Int. Cl. H04W 36/32; H04W 36/30; H04W 64/00; H04W 72/12; H04W 56/00; H04M 7/00

(52) U.S. Cl. CPC H04W 36/32; H04W 36/30; H04W 64/006; H04L 47/283; H04W 56/007; H04M 7/0066; H04W 72/1226

(57) ABSTRACT

A device includes a receiver configured to wirelessly receive packets associated with a packet-based communication. The device includes a high-speed motion detector configured to determine whether motion data corresponding to an end device of the packet-based communication indicates a high-speed condition of the end device. The device also includes a high-speed motion compensator configured to adjust a configuration setting associated with the packet-based communication in response to the motion data indicating the high-speed condition.

### I. FIELD

The present disclosure is generally related to packet-based communications.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, may communicate voice and data packets over wireless networks. Further, many such wireless telephones include other types of devices that are incorporated therein. For example, a wireless telephone may also include a digital still camera, a digital video camera, a digital recorder, and an audio file player. Also, such wireless telephones may process executable instructions, including software applications, such as a web browser application, that may be used to access the Internet. As such, these wireless telephones may include significant computing capabilities.

Electronic devices, such as wireless telephones, may send and receive data via networks. For example, audio data may be sent and received via a circuit-switched network (e.g., the public switched telephone network (PSTN), a global system for mobile communications (GSM) network, etc.) or a packet-switched network (e.g., a voice over internet protocol (VoIP) network, a voice over long term evolution (VoLTE) network, etc.). In a packet-switched network, audio packets corresponding to a sequence of audio frames may be individually routed from a source device to a destination device. Due to network conditions, the audio packets may arrive out of order. The destination device may store received packets in a de-jitter buffer and may rearrange the received packets if the received packets are out of order.

The destination device may generate a processed audio signal based on the received packets. A particular packet sent by the source device may not be received by a destination device, or may be received with errors, or may be received out of order or after a delay. For example, a handover event in which a device engaged in a VoIP call moves from one wireless network to another (e.g., an inter-radio access technologies (inter-RAT) handover) or from one area of coverage to another in the same wireless network (e.g., an intra-RAT handover) may result in out-of-order, delayed, corrupted, or lost packets at the destination device. Issues due to the out-of-order, delayed, corrupted, or lost packets may be at least partially resolved at the de-jitter buffer prior to playback of the content of the packets with little to no noticeable effect by an operator of the destination device. However, when the destination device begins high-speed travel that causes a relatively high rate of handover events, such as when used on a high-speed train departing its station, the onset of a high rate of handover events can cause an increased amount of packet delays, lost packets, and corrupted packets, and each handover event can take significantly longer as compared to handovers at lower speeds, resulting in noticeable loss of quality of the VoIP call.

### III. SUMMARY

According to one implementation of the present disclosure, a device includes a receiver configured to wirelessly receive packets associated with a packet-based communication. The device includes a high-speed motion detector configured to determine whether motion data corresponding to an end device of the packet-based communication indicates a high-speed condition of the end device. The device also includes a high-speed motion compensator configured to adjust a configuration setting associated with the packet-based communication in response to the motion data indicating the high-speed condition.

According to another implementation of the present disclosure, a method includes determining, at a device, that motion data corresponding to the device indicates a high-speed condition of the device. The method also includes, in response to detecting that the motion data indicates the high-speed condition, adjusting at least one of a de-jitter buffer configuration or a redundancy configuration associated with a packet-based communication at the device.

According to another implementation of the present disclosure, a non-transitory computer-readable medium includes instructions that, when executed by a processor, cause the processor to perform operations including determining, at a device, that motion data corresponding to the device indicates a high-speed condition of the device. The operations also include, in response to detecting that the motion data indicates the high-speed condition, adjusting at least one of a de-jitter buffer configuration or a redundancy configuration associated with a packet-based communication at the device.

According to another implementation of the present disclosure, an apparatus includes means for wirelessly receiving packets associated with a packet-based communication. The apparatus includes means for determining whether motion data corresponding to an end device of the packet-based communication indicates a high-speed condition of the end device. The apparatus also includes means for adjusting a configuration setting associated with the packet-based communication in response to the motion data indicating the high-speed condition.

### IV. BRIEF DESCRIPTION OF THE DRAWINGS

FIG. 1 is a block diagram of a particular illustrative implementation of a system including a device that is operable to compensate for high-speed travel in packet-based communications.

FIG. 2 is a diagram of a system that includes a particular implementation of the device of FIG. 1.

FIG. 3 is a diagram of a particular implementation of a de-jitter buffer that may be implemented in the device of FIG. 1.

FIG. 4 is a diagram of a particular implementation of a redundancy manager and a packet stream showing redundancy settings that may be implemented in the device of FIG. 1.

FIG. 5 is a flow chart of a particular implementation of a method of compensating for high-speed travel in packet-based communications.

FIG. 6 is a flow chart of another particular implementation of a method of compensating for high-speed travel in packet-based communications.

FIG. 7 is a block diagram of a particular illustrative implementation of a device that is operable to compensate for high-speed travel in packet-based communications.

FIG. 8 is a block diagram of a base station that is operable to compensate for high-speed travel in packet-based communications.

### V. DETAILED DESCRIPTION

The principles described herein may be applied, for example, to a headset, a handset, other audio device, or a component of a device that is configured to use a de-jitter buffer. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from another component, block or device), and/or retrieving (e.g., from a memory register or an array of storage elements).

Unless expressly limited by its context, the term “producing” is used to indicate any of its ordinary meanings, such as calculating, generating, and/or providing. Unless expressly limited by its context, the term “providing” is used to indicate any of its ordinary meanings, such as calculating, generating, and/or producing. Unless expressly limited by its context, the term “coupled” is used to indicate a direct or indirect electrical or physical connection. If the connection is indirect, there may be other blocks or components between the structures being “coupled”.

The term “configuration” may be used in reference to a method, apparatus/device, and/or system as indicated by its particular context. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). In the case (i) where A is based on B includes based on at least, this may include the configuration where A is coupled to B. Similarly, the term “in response to” is used to indicate any of its ordinary meanings, including “in response to at least.” The term “at least one” is used to indicate any of its ordinary meanings, including “one or more”. The term “at least two” is used to indicate any of its ordinary meanings, including “two or more”.

The terms “apparatus” and “device” are used generically and interchangeably unless otherwise indicated by the particular context. Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The terms “method,” “process,” “procedure,” and “technique” are used generically and interchangeably unless otherwise indicated by the particular context. The terms “element” and “module” may be used to indicate a portion of a greater configuration. The term “packet” may correspond to a unit of data that includes a header portion and a payload portion. Any incorporation by reference of a portion of a document shall also be understood to incorporate definitions of terms or variables that are referenced within the portion, where such definitions appear elsewhere in the document, as well as any figures referenced in the incorporated portion.

As used herein, the term “communication device” refers to an electronic device that may be used for voice and/or data communication over a wireless communication network. Examples of communication devices include cellular phones, personal digital assistants (PDAs), handheld devices, headsets, wireless modems, laptop computers, personal computers, etc.

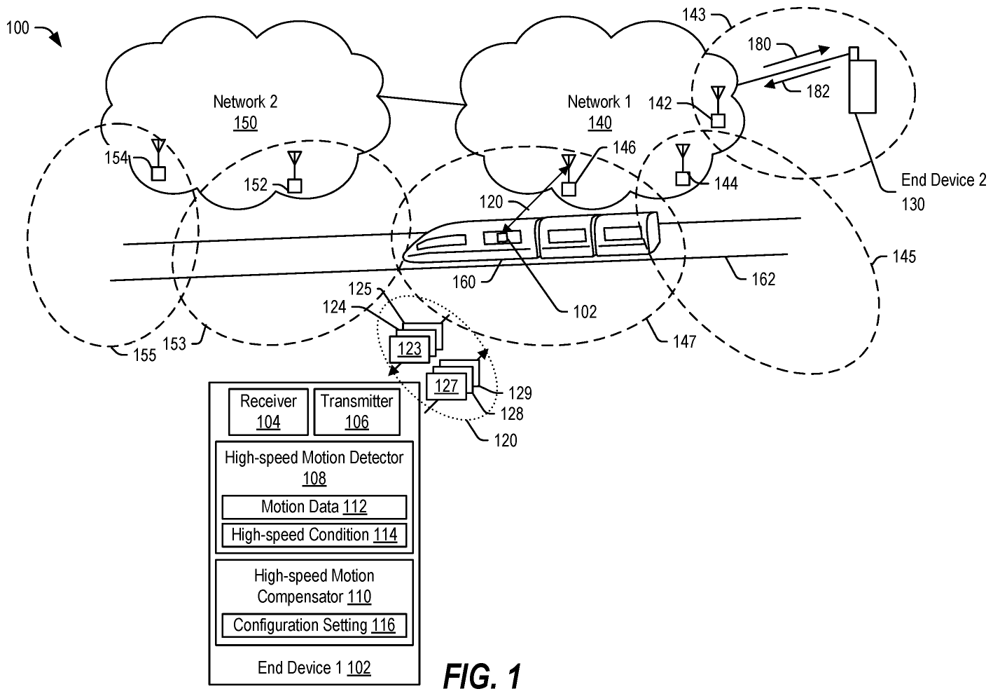

Referring to FIG. 1, a particular illustrative implementation of a system including a device that is operable to compensate for high-speed travel in packet-based communications is disclosed and generally designated 100. The system 100 includes a device 102, also referred to as a first end device 102 of a packet-based communication 120. The first end device 102 is in communication with another device 130, also referred to a second end device 130 of the packet-based communication 120, via a first network 140. The first end device 102 is configured to adjust a configuration setting 116 in response to detecting that motion data 112 indicates a high-speed condition 114. Adjusting the configuration setting 116 at least partially compensates for an effect of high-speed travel of the first end device 102, such as travel on a high-speed train 160.

The second end device 130 is within a first coverage area 143 of a first base station 142 of the first network 140 and communicates with the first end device 102 via first packets 180 received at the second end device 130 and second packets 182 sent by the second end device 130. A path 162 of the high-speed train 160 causes the first end device 102 to enter and exit a sequence of coverage areas including a second coverage area 145 of a second node 144 of the first network 140, a third coverage area 147 of a third node 146 of the first network 140, a fourth coverage area 153 of a fourth node 152 of a second network 150, and a fifth coverage area 155 of a fifth node 154 of the second network 150. The first network 140 and the second network 150 are packet-switched networks, such as VoLTE networks, and the first network 140 is coupled to the second network 150.

An example implementation of the first end device 102 includes a receiver 104, a transmitter 106, a high-speed motion detector 108, and a high-speed motion compensator 110. The receiver 104 is configured to wirelessly receive packets associated with a packet-based communication, such as representative incoming packets 123, 124, and 125 of the packet-based communication 120. The transmitter 106 is configured to wirelessly transmit outgoing packets, such representative outgoing packets 127, 128, and 129 of the packet-based communication 120. Each of the packets 123-125 and 127-129 may include data associated with the packet-based communication 120, such as encoded voice data associated with a VoIP call.

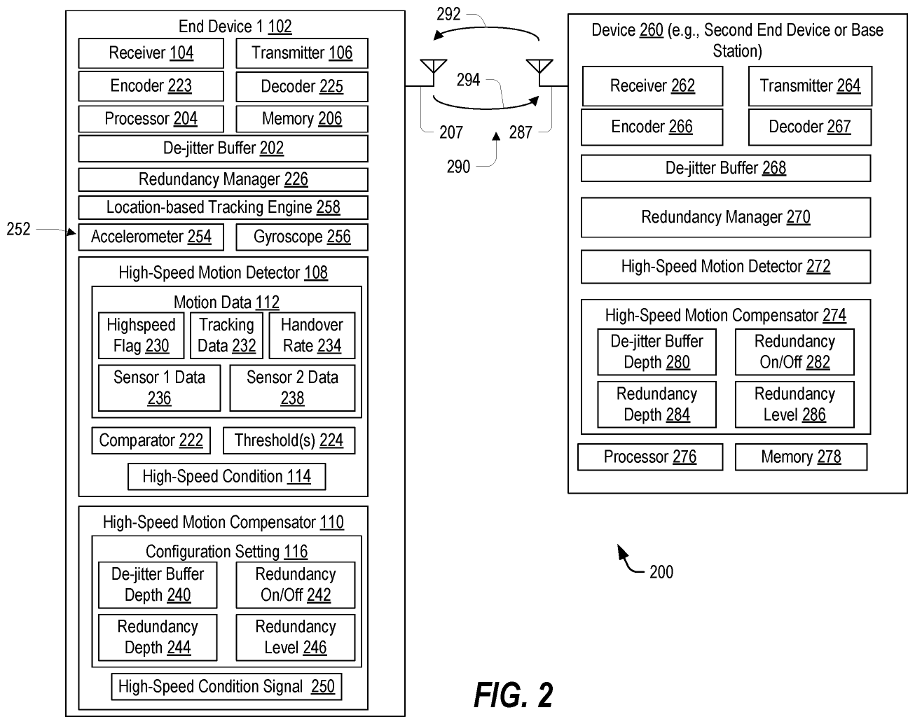

The high-speed motion detector 108 is configured to determine whether the motion data 112 indicates the high-speed condition 114 of the first end device 102. The high-speed condition 114 is indicative of high-speed travel of the first end device 102 that results in increased packet delay variation (“packet jitter”), packet loss, packet corruption, or a combination thereof, due to an increased rate of wireless handover events at the first end device 102 and an increased duration of each of the wireless handover events. The motion data 112 corresponds to the first end device 102 and indicates motion of the first end device 102. In some implementations, the motion data 112 includes motion sensor data, location-based tracking data, data received from a base station indicating a speed of the first end device 102, a handover event rate, one or more other types of motion data, or any combination thereof. Examples of the motion data 112 are described in further detail with reference to FIG. 2.

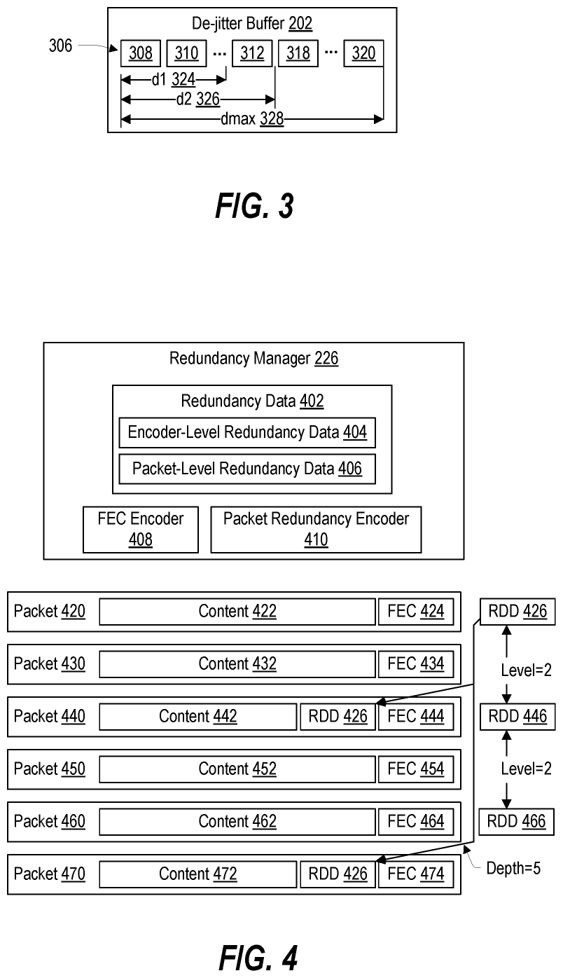

The high-speed motion compensator 110 is configured to adjust the configuration setting 116 in response to the motion data 112 indicating the high-speed condition 114. The configuration setting 116 is associated with the packet-based communication 120. In a first example, the configuration setting 116 corresponds to a depth of a de-jitter buffer of the first end device 102, and increasing the depth of the de-jitter buffer improves a quality of the packet-based communication 120 by reducing a number of delayed packets that are not received in the de jitter buffer in sufficient time for playback. In a second example, the configuration setting 116 corresponds to a redundancy setting that is adjusted to add redundancy data such as forward error correction (FEC) data, reduce a redundancy depth, increase a redundancy level, or a combination thereof, to reduce a number of packets that are unplayable at the second end device 130 due to packet loss or packet corruption. Examples of the configuration setting 116 are described in further detail with reference to FIG. 2, examples of a de-jitter buffer are described in further detail with reference to FIGS. 2-3, and examples of redundancy settings are described in further detail with reference to FIG. 2 and FIG. 4.

In some implementations, the high-speed motion compensator 110 is configured, in response to the motion data 112 indicating the high-speed condition 114, to transmit a signal that indicates the high-speed condition 114. In an example, the high-speed motion compensator 110 causes the transmitter 106 to send a signal to indicate the high-speed condition of the first end device 102. In some implementations, the signal is received by the node 146 and causes the node 146 to modify operation to compensate for the high-speed travel of the first end device 102, such as by adding or adjusting redundancy data for the incoming packets 123-125, increasing a depth of a de-jitter buffer in the node 146, or a combination thereof. In some implementations, the signal is routed to the second end device 130 and causes the second end device 130 to modify operation to compensate for the high-speed travel of the first end device 102, such as by adding or adjusting redundancy data for packets of the packet-based communication 120 sent by the second end device 130, increasing a depth of a de-jitter buffer in the second end device 130, or a combination thereof. An example of sending a signal that indicates the high-speed condition 114 is described in further detail with reference to FIG. 2.

During operation, in an illustrative example, the first end device 102 (e.g., a mobile phone) initiates the packet-based communication 120 with the second end device 130 while the first end device 102 is in the second coverage area 145, such as when an operator of the first end device 102 awaits departure of the high-speed train 160 from a train station. The high-speed motion detector 108 monitors the motion data 112 for updates that may indicate the high-speed condition 114. Because the high-speed train 160 has not yet started moving, the first end device 102 selects a “normal” (e.g., appropriate for non-high-speed motion) value of the configuration setting 116.

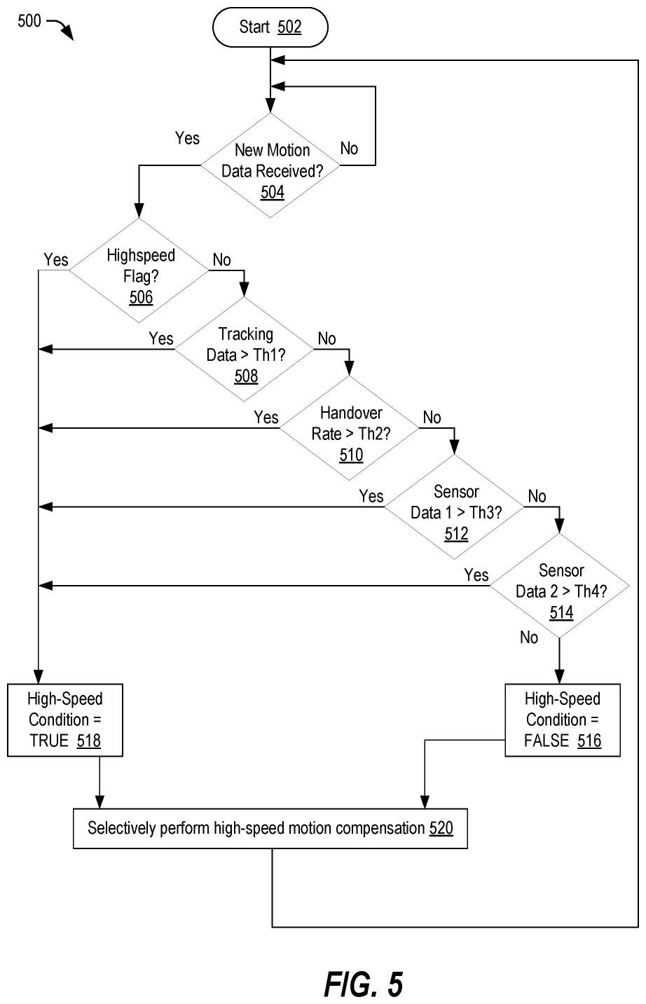

Upon initiation of high-speed motion of the high-speed train 160, the motion data 112 is updated to have one or more values that indicate high-speed motion of the first end device 102. The high-speed motion detector 108 detects that the motion data 112 indicates the high-speed condition 114. Examples of detecting that the motion data 112 indicates the high-speed condition 114 are described in further detail with reference to FIG. 2 and FIG. 5.

In response to determining the high-speed condition, the high-speed motion compensator 110 updates a value of the configuration setting 116 to at least partially compensate for a predicted increased duration of handover events and a predicted increased rate of handover events resulting from the high-speed motion. As described in further detail with reference to FIGS. 2-4, the updated value of the configuration setting 116 may increase a depth of a de jitter buffer of the first end device 102, initiate or increase an amount of redundancy associated with the packet-based communication 120, send a high-speed indication signal to indicate to the second end device 130 that the first end device 102 is undergoing high-speed motion, or a combination thereof. In response, the second end device 130 may also adjust one or more configuration settings associated with the packet-based communication 120, as described further with reference to FIG. 2.

By adjusting the configuration setting 116 in response to detecting the high-speed condition 114, the first end device 102, the second end device 130, or both, may experience reduced (or eliminated) packet loss when the first end device 102 undergoes high-speed handover events, such as when transitioning from the second coverage area 145 of the second base station 144 to the third coverage area 147 of the third base station 146, from the third coverage area 147 to the fourth coverage area 153 of the fourth base station 152, and from the fourth coverage area 153 to the fifth coverage area 155 of the fifth base station 154. Thus, a quality of the packet-based communication 120 (e.g., a voice call) is improved as compared to a system that does not adjust configuration settings corresponding to a packet-based communication in response to detecting high-speed motion of an end device of the packet-based communication.

Although FIG. 1 illustrates “high-speed travel” of the first end device 102 as motion of the first end device 102 due to travel on the high-speed train 160, in other implementations the first end device 102 engages in high-speed travel via other mechanisms, such as fast automobile travel, aircraft or aerospace travel, boat travel, projectile motion of the first end device 102, or movement of the first end device 102 via pneumatic tube, high-speed elevator, or free-fall, as illustrative, non-limiting examples. Although the second end device 130 is described as remaining in the first coverage area 143 while the first end device 102 engages in high-speed travel, in other implementations the second end device 130 may also engage in travel that results in handover events, such as high-speed travel, non-high-speed travel, or a combination thereof.

Although FIG. 1 illustrates two networks 140 and 150, in other implementations the system 100 includes a single network or more than two networks. Although the first network 140 is illustrated as having three base stations and the second network 150 is illustrated as having two base stations, in other implementations networks within the system 100 have other numbers of base stations, and the path of high-speed travel of an end device moves through any number of coverage areas of each network. Although the networks 140, 150 are described as including base stations as hardware devices that provide coverage areas to allow a wireless device to connect to the wireless network for packet-based communications, in other implementations the base stations are other types of hardware devices to allow wireless access to the network via other radio access technologies, such as Node B devices in 3G implementations, evolved Node B (eNB) devices in LTE implementations, access points in Institute of Electrical and Electronics Engineers (IEEE) 802.11-type (e.g., WiFi) implementations, or any other hub of a wireless network that may serve as a gateway to a wired network.

The first end device 102 may include fewer or more components than illustrated in FIG. 1. For example, the first end device 102 may include one or more processors, one or more memory units, or both. The first end device 102 may include a networked or a distributed computing system. In a particular illustrative implementation, the first end device 102 includes a communication device, a decoder, a smart phone, a cellular phone, a mobile communication device, a laptop computer, a computer, a tablet, a personal digital assistant (PDA), a set top box, a video player, an entertainment unit, a display device, a television, a gaming console, a music player, a radio, a digital video player, a digital video disc (DVD) player, a tuner, a camera, a navigation device, or a combination thereof. Such devices may include a user interface (e.g., a touch screen, voice recognition capability, or other user interface capabilities).

Referring to FIG. 2, a particular illustrative implementation of the first end device 102 in communication with another device 260 is illustrated. The first end device 102 receives incoming packets 292 of a packet-based communication 290 from the device 260 and sends outgoing packets 294 of the packet-based communication 290 to be received by the device 260. In some implementations, the packet-based communication 290 corresponds to the packet-based communication 120 of FIG. 1 and the device 260 includes a second end device, such as the second end device 130 of FIG. 1. In some implementations, the device 260 includes a base station or other component of a wireless network, such as the base station 146 of FIG. 1.

The first end device 102 includes the receiver 104, the transmitter 106, the high-speed motion detector 108, and the high-speed motion compensator 110. The first end device 102 also includes an antenna 207, an encoder 223, a decoder 225, a processor 204, a memory 206, a de-jitter buffer 202, a redundancy manager 226, a location-based tracking engine 258, and motion sensors 252 including an accelerometer 254 and a gyroscope 256.

The encoder 223 is configured to generate the outgoing packets 294 associated with the packet-based communication 290, and the transmitter 106 is coupled to the antenna 207 and configured to wirelessly transmit the outgoing packets 294. The antenna 207 is coupled to the receiver 104 and is configured to receive the incoming packets 292, and the decoder 225 is configured to decode the received packets 292. In some implementations, the antenna 207 includes multiple antenna elements, such as an antenna array.

The de-jitter buffer 202 is configured to store packets of the packet-based communication 290. Each received packet is placed in its sequential playback order position in the de-jitter buffer 202 and delayed by an amount corresponding to the “depth” of the de-jitter buffer 202 prior to playback of the content encoded in the packet. An example of the de-jitter buffer 202 is described in further detail with reference to FIG. 3.

The redundancy manager 226 is configured to selectively generate redundancy data associated with one or more of the outgoing packets 294. The redundancy manager 226 is configurable to turn on or turn off generation of redundancy data, to generate the redundancy data in accordance with a redundancy depth, a redundancy level, one or more other redundancy settings, or a combination thereof. The redundancy manager 226 is configured to increase the redundancy level by increasing a proportion of the outgoing packets that are processed to generate redundancy data and to decrease the redundancy depth by reducing a number of the outgoing packets that are between a particular packet and redundancy data for the particular packet. Examples of the redundancy manager 226 and redundancy data are described in further detail with reference to FIG. 4.

The location-based tracking engine (“location engine”) 258 is configured to track a location of the first end device 102. For example, the location-based tracking engine 258 may include a map-based application that tracks a geographic location of the first end device 102 based on global positioning system (GPS) data, available wireless network data, one or more other types of location information, or a combination thereof.

The high-speed motion detector 108 is configured to process the motion data 112 to determine if high-speed motion is detected. The motion data 112 includes one or more components indicative of motion of the first end device 102. One or more of the components of the motion data 112 may indicate high-speed motion of the first end device 102, enabling the first end device 102 to initiate compensation for the high-speed motion.

In some implementations, the motion data 112 includes a highspeed flag 230 that is received by the first end device 102. To illustrate, the receiver 104 is configured to receive the highspeed flag 230 via a wireless network, such as the first wireless network 140 of FIG. 1. In some implementations, the highspeed flag 230 is received as a value in a system information block-2 (SIB2) message from a base station (e.g., the second base station 144) of the wireless network to provide radio resource configuration information associated with the wireless network. In an illustrative example, the highspeed flag having a first value (e.g., TRUE) indicates high-speed travel of the first end device 102, and the highspeed flag 230 having a second value (e.g., FALSE) does not indicate high-speed travel of the first end device 102. Although the motion data 112 is illustrated as including the highspeed flag 230, in other implementations the motion data 112 does not include the highspeed flag 230.

In some implementations, the motion data 112 includes location-based tracking data 232 that is generated by the location-based tracking engine 258. The location-based tracking data 232 may indicate a rate of travel of the first end device 102 based on tracking a location of the first end device 102 over a particular length of time. Although the motion data 112 is illustrated as including the location-based tracking data 232, in other implementations the motion data 112 does not include the location-based tracking data 232, such as an implementation in which the location-based tracking engine 258 is omitted or an implementation in which the location-based tracking engine 258 is deactivated.

In some implementations, the motion data 112 includes a handover rate 234 that is indicative of a rate of handover events of the first end device 102, such as a count of a number of handover events that are detected within a specified time period. Although the motion data 112 is illustrated as including the handover rate 234, in other implementations the motion data 112 does not include the handover rate 234.

In some implementations, the motion data 112 includes first motion sensor data 236 generated by the accelerometer 254. The first motion sensor data 236 may include acceleration measurements that enable estimation of a travel speed of the first end device 102. Although the motion data 112 is illustrated as including the first motion sensor data 236, in other implementations the motion data 112 does not include the first motion sensor data 236, such as an implementation in which the accelerometer 254 is omitted or an implementation in which the accelerometer 254 is deactivated.

In some implementations, the motion data 112 includes second motion sensor data 238 generated by the gyroscope 256. The second motion sensor data 238 may include gyroscopic measurements that enable estimation of a travel speed of the first end device 102. Although the motion data 112 is illustrated as including the second motion sensor data 238, in other implementations the motion data 112 does not include the second motion sensor data 238, such as an implementation in which the gyroscope 256 is omitted or an implementation in which the gyroscope 256 is deactivated.

The high-speed motion detector 108 is configured to analyze the motion data 112 to determine whether the high-speed condition 114 is satisfied. In some implementations, one or more elements of the motion data 112 are compared to a one or more thresholds 224 via a comparator 222 to determine high-speed motion. In an example, the location-based tracking data 232, the first motion sensor data 236, and the second motion sensor data 238 are converted to standardized units of speed (e.g., kilometers per hour (kph)) and compared to a threshold 224 indicative of high-speed travel, such as 200 kph, 250 kph, or another threshold speed, as illustrative, non-limiting examples. In response to detecting high-speed motion based on the motion data 112, the high-speed motion detector 108 is configured to set an indication of the high-speed condition 114 to a value indicating that the high-speed condition 114 is satisfied.

The high-speed motion compensator 110 is configured to adjust the configuration setting 116 in response to detection that the high-speed condition 114 is satisfied. In some implementations, the configuration setting 116 includes a depth 240 of the de jitter buffer 202. In some implementations, the configuration setting 116 includes one or more redundancy settings, such as a redundancy on/off setting 242, a redundancy depth 244, a redundancy level 246, or any combination thereof.

The high-speed motion compensator 110 is configured to increase the depth of the de-jitter buffer 202 in response to the motion data 112 indicating the high-speed condition 114. Alternatively, or in addition, in response to detection that the high-speed condition 114 is satisfied, the high-speed motion compensator 110 is configured to adjust the redundancy setting (e.g., the redundancy on/off setting 242, the redundancy depth 244, the redundancy level 246, or a combination thereof) to cause the redundancy manager 226 to at least one of: initiate generating the redundancy data, increase a redundancy level of the redundancy data, decrease a redundancy depth of the redundancy data, or any combination thereof.

In some implementations, the high-speed motion compensator 110 is configured to transmit a high-speed condition signal 250 that indicates the high-speed condition 114. Transmitting the high-speed condition signal 250 enables the device 260 (e.g., an end device or a base station) to at least one of: increase a depth of a second de-jitter buffer 268 at the device 260; initiate generating redundancy data associated with sending the packets 292 from the device 260 to the first end device 102; increase a redundancy level of the redundancy data generated for the packets 292 by increasing a proportion of the packets that include the redundancy data (or increasing a proportion of each packets used for redundancy data); or decrease a redundancy depth of the redundancy data generated for the packets 292 by reducing a number of packets that are between a first packet and first redundancy data for the first packet.

The device 260 includes an antenna 287, a receiver 262, a transmitter 264, an encoder 266, a decoder 267, the de-jitter buffer 268, a redundancy manager 270, a high-speed motion detector 272, a high-speed motion compensator 274, a processor 276, and a memory 278. The antenna 287 is coupled to the receiver 262 to enable receiving of the packets 294, and the decoder 267 is configured to decode the received packets 294. The antenna 287 is coupled to the transmitter 264 to send the packets 292 generated by the encoder 266.

The de-jitter buffer 268, the redundancy manager 270, the high-speed motion detector 272, and the high-speed motion compensator 274 are analogous to the de-jitter buffer 202, the redundancy manager 226, the high-speed motion detector 108, and the high-speed motion compensator 110 of the first end device 102 and operate in a similar manner as described. In addition, the high-speed motion compensator 274 is responsive to receipt of the high-speed condition signal 250 at the device 260 to adjust a de-jitter buffer depth 280, a redundancy on/off setting 282, a redundancy depth 284, or a redundancy level 286. Increasing the de-jitter buffer depth 280 reduces a likelihood of lost packets of the packets 294 due to increased packet jitter of the packets 294 from the first end device 102. Initiating or increasing an amount of redundancy data that is added to the packets 292 sent to the first end device 102 increases the likelihood that lost or corrupted packets can be at least partially recovered prior to playback at the first end device 102.

Although various components of the first end device 102 and the device 260 are illustrated as separate hardware or circuitry components, in other implementations one or more of the components of the first end device 102, the device 260, or both, correspond to a processor executing processing instructions to obtain the described functionality. For example, the redundancy manager 226, the location-based tracking engine 258, the high-speed motion detector 108, the high-speed motion compensator 110, or a combination thereof, may be implemented as the processor 204 executing instructions from the memory 206 to perform the described functions. As another example, the redundancy manager 270, the high-speed motion detector 272, the high-speed motion compensator 274, or a combination thereof, may be implemented as the processor 276 executing instructions from the memory 278 to perform the described functions. In addition, the de-jitter buffer 202, the motion data 112, the one or more thresholds 224, the configuration settings 116, one or more other settings or data, or a combination thereof, may be maintained in the memory 206 rather than separate storage components of the first end device 102, and the de jitter buffer 268, the de jitter buffer depth 280, the redundancy on/off setting 282, the redundancy depth 284, the redundancy level 286, one or more other settings or data, or a combination thereof, may be maintained in the memory 278 rather than separate storage components of the device 260.

Although each of the first end device 102 and the device 260 are illustrated having various components, in other implementations the first end device 102, the second end device 260, or both, have additional components or fewer components than illustrated in FIG. 2. To illustrate, in some implementations, the first end device 102 omits the location-based tracking engine 258 and one or both of the motion sensors 252 and determines the high-speed condition based on the highspeed flag 230, based on the handover rate 234, or a combination thereof. Although the high-speed motion compensator 110 is configured to adjust the de-jitter buffer depth, adjust redundancy settings, and send the high-speed condition signal 250, in other implementations at least partial high-speed motion compensation is obtained by performing one or more, but not all, of adjusting the de-jitter buffer depth, adjusting the redundancy settings, or sending the high-speed condition signal 250.

FIG. 3 depicts a particular example of the de-jitter buffer 202 of FIG. 2. As illustrated in FIG. 3, the de jitter buffer 202 is configurable to store packets prior to a playout of the content associated with each of the buffered packets. For example, the de jitter buffer 202 is illustrated as storing a set of packets 306 including a first packet 308, a second packet 310, a third packet 312, a fourth packet 318, and a fifth packet 320. Each of the packets 308-320 may include a sequence number or timestamp identifying a position of the particular packet in the sequence of packets that are received at the de jitter buffer 202. The de jitter buffer 202 is configured to restore a playback sequence of the packets 308-320 and to buffer the packets until a playout time for each individual packet occurs. In the event that a particular packet of a playout sequence has not been received at the de-jitter buffer 202 prior to a playout time for that packet, audio content associated with the packet may be reproduced by a redundancy data that may be included in another packet within the de-jitter buffer 202, via interpolation or extrapolation of one or more other packets, or by including a silence or a lack of content for the packet.

The de-jitter buffer 202 has an adjustable depth. As used herein, a “depth” of the de-jitter buffer 202 indicates a number of packets that can be stored in the de-jitter buffer 202. For example, the de-jitter buffer 202 may be configured to have a first depth (d1) 324 that enables a first number of packets to be buffered in the de-jitter buffer 202. The de-jitter buffer 202 may also be configured to have a second depth (d2) 326, which enables a second number of packets (that is larger than the first number) to be buffered, or a third depth (dmax) 328 which enables a number of packets to be buffered up to a largest storage capacity of the de-jitter buffer 202.

The de-jitter buffer 202 may be managed so that when a rate of lost packets exceeds a threshold, a depth of the de-jitter buffer 202 is increased, which increases a playback delay time associated with content received at the de-jitter buffer 202 and provides additional time for increased jitter of received packets to be compensated for in the de jitter buffer 202 prior to the playback time of the received packets. As a result, increasing the depth of the de-jitter buffer 202 enables a greater variability of delay in packets received at the de-jitter buffer 202, such as delays due to handover events.

Although the de-jitter buffer 202 may be configured to increase the depth based on detecting an increased number of lost packets, such dynamic management of the de-jitter buffer 202 may occur too slowly to compensate for effects of high-speed travel of the first end device 102. As a result, when the high-speed motion detector 108 detects the high-speed condition 114, the high-speed motion compensator 110 can automatically increase the de-jitter buffer depth to the third depth (dmax) 328, thus increasing the playback delay time to a largest acceptable delay and maximizing the potential for delayed packets to be recovered in the de-jitter buffer 202 prior to the playback time of the delayed packets. Because a managed, incrementally increasing depth of the de jitter buffer 202 that may be sufficient under normal conditions may be insufficient to prevent degraded quality during high-speed travel conditions, the depth of the de jitter buffer 202 is automatically increased in response to detecting the high-speed condition 114 to at least partially compensate for decreased playback quality due to the high-speed motion. It should be understood that the increase of the depth of the de-jitter buffer 202 may occur prior to any high-speed handovers being initiated, and thus may serve as a proactive compensation for potential jitter due to high-speed travel and increased number of handovers. After initially increasing the depth to the third depth (dmax) 328, de-jitter management circuitry may gradually reduce the depth to obtain a reduced playback delay that also maintains an acceptable packet loss rate that does not substantially affect a playback quality of the packet-based communication.

Although three depths 324-328 are described, any number of depths may be used. Although in some implementations the depth of the de-jitter buffer 202 is set to a maximum buffer depth in response to detecting the high-speed condition, in other implementations the depth of the de jitter buffer 202 is instead set to less than the maximum buffer depth, such as one-half of the maximum buffer depth or three-quarters of the maximum buffer depth, as illustrative, non-limiting examples. In some examples, the buffer depth may be set based on historical buffer depths that were determined to provide sufficient packet-based communication quality during high-speed travel. To illustrate, the buffer depth may be selected by comparing a speed of travel of the first end device 102 to historical speed data to select or compute a buffer depth based on historical buffer depth data associated with the historical speed data.

FIG. 4 depicts a particular example of the redundancy manager 226 of FIG. 2. The redundancy manager 226 includes a forward error correction (FEC) encoder 408 and a packet redundancy encoder 410. The redundancy manager 226 is configured to operate the FEC encoder 408, the packet redundancy encoder 410, or a combination thereof, to generate redundancy data 402. In implementations in which the FEC encoder 408 is activated, the redundancy data 402 includes encoder-level redundancy data 404. In implementations in which the packet redundancy encoder 410 is activated, the redundancy data 402 includes packet-level redundancy data 406. In some implementations, the redundancy data 402 includes the encoder-level redundancy data 404 and also includes the packet-level redundancy data 406.

The FEC encoder 408 generates the encoder-level redundancy data 404 that enables error detection and correction of one or more corrupted portions of the content within an encoded packet. For example, the encoder-level redundancy data 404 may be included in a packet to enable a decoder at a receiver of the packet to detect and correct one or more bit errors of the packet payload that occur during transmission of the packet. As a result, packets that may otherwise be considered as lost or unplayable due to bit errors in the packet payload may be correctable at the receiver for playback.

The packet redundancy encoder 410 is configured to generate redundant data corresponding to the content of one packet to be transmitted in a later packet. For example, the packet-level redundancy data 406 may include a partial copy or a reduced resolution version of the content of a first packet to be included in a later packet of the packet stream. As a result, if the first packet is delayed or lost, redundancy data of the lost packet may be received with the later packet and used to create a partial replacement of the content of the first packet at a playback time of the first packet.

To illustrate, a series of packets including a first packet 420, a second packet 430, a third packet 440, a fourth packet 450, a fifth packet 460, and a sixth packet 470 are depicted as a sequence of packets associated with a packet-based communication, such as a VOIP call. The first packet 420 includes first content 422, such as encoded voice content, and first FEC redundancy data 424 generated by the FEC encoder 408 to enable detection and correction of one or more bit errors that may occur in the first content 422, up to a correction capability of the forward error correction encoding and decoding technique. The second packet 430 includes second content 432 and second FEC data 434. The third packet 440 includes third content 442 and third FEC data 444. The fourth packet 450 includes fourth content 452 and fourth FEC data 454. The fifth packet 460 includes fifth content 462 and fifth FEC data 464. The sixth packet 470 includes sixth content 472 and sixth FEC data 474.

The first content 422 is processed by the packet redundancy encoder 410 to generate first redundant data (RDD) 426. The first redundant data 426 corresponds the packet-level redundancy data 406 and is buffered to be included in a later packet of the series of packets based on the redundancy depth. The redundancy depth corresponds to a number of packets distance in the sequence of packets between the content containing packet and the later packet that includes the redundancy data. As illustrated, when the redundancy depth is set to 2, the first redundant data 426 is included in the third packet 440, and when the redundancy depth is 5, the first redundant data 426 is included in the sixth packet 470.

The packet redundancy encoder 410 may be controlled to adjust a redundancy level of the packet-level redundancy data 406. For example, when the redundancy level is set to 2, redundancy data is generated for every second packet, illustrated as the first redundant data 426 for the first packet 420, redundant data 446 for the third packet 440, and redundant data 466 for the fifth packet 460. In other implementations, the redundancy level may be increased to 3, 4, or more, thus reducing the percentage of packets that are protected with packet-level redundancy. Alternatively, the redundancy level may be decreased to 3/2, 5/4, or another value down to 1. For example, when the redundancy level is 3/2, packet level redundancy data is generated for 2 of every 3 packets in the sequence, and when the redundancy level is 1, packet level redundancy is generated for every packet of the sequence.

In response to detecting high-speed motion, the high-speed motion compensator 110 may adjust one or more of the configuration settings associated with the redundancy manager 226. For example, the high-speed motion compensator 110 may turn on one or more redundancies, such as activating the FEC encoder 408 to generate the encoder-level redundancy data 404, turning on the packet redundancy encoder 410 to initiate generation of the packet-level redundancy data 406, or a combination thereof. In addition, or alternatively, the high-speed motion compensator 110 may decrease the redundancy depth to increase a probability that redundancy data for any lost packet is available in a later-received packet within a de jitter buffer of the receiving device. As another example, the redundancy manager 226 may be controlled to reduce the redundancy level to increase the percentage of packets having packet-level redundancy and therefore to reduce an impact on quality of the packet-based communication if one or more packets are lost prior to playback.

By adjusting one or more configuration settings associated with the redundancy manager 226, such as the redundancy on/off setting 242, the redundancy depth setting 244, the redundancy level 246, or a combination thereof, an impact on the quality of communication of the packet-based communication due to lost or corrupted packets may be reduced or avoided. It should be noted that the configuration of the redundancy manager 226 may be adjusted in response to detecting the high-speed condition 114, and prior to any actual loss of packets occurring, as a proactive measure in anticipation of an increased rate and extended length of hand-over events due to high-speed motion of the first end device 102. Thus, the quality of the packet-based communication may be maintained with little or no degradation due to the high-speed motion as compared to techniques in which adjustments to redundancy settings are incrementally made responsive to detection of lost or corrupted packets.

Referring to FIG. 5, a particular implementation of a method 500 is depicted that may be performed by the first end device 102 of FIG. 2 to compensate for high-speed travel in packet-based communications. The method 500 starts, at 502, and includes determining whether new motion data has been received, at 504. For example, the motion data may correspond to the motion data 112 of FIG. 2.

In response to determining that new motion data has been received, at 504, the method 500 includes determining whether the motion data includes the highspeed flag 230 indicating high-speed motion, at 506. In response to the motion data including the highspeed flag 230, an indicator of the high-speed condition 114 is set to TRUE, at 518. Otherwise, the method 500 includes determining whether the tracking data 232 exceeds a first threshold (Th1) of the one or more thresholds 224, at 508.

In response to determining that the tracking data 232 exceeds the first threshold, at 508, the method 500 includes setting the indicator of the high-speed condition 114 to TRUE, at 518. Otherwise, the method 500 includes determining whether the handover rate 234 exceeds a second threshold (Th2), at 510.

In response to determining that the handover rate 234 exceeds the second threshold, at 510, the method 500 includes setting the indicator of the high-speed condition 114 to TRUE, at 518. Otherwise, the method 500 includes determining whether the first motion sensor data 236 exceeds a third threshold (Th3), at 512.

In response to the first motion sensor data 236 exceeding the third threshold, at 512, the method 500 includes setting the indicator of the high-speed condition 114 to TRUE, at 518. Otherwise, the method 500 includes determining whether the second motion sensor data 238 exceeds a fourth threshold (Th4), at 514.

In response to the second motion sensor data 238 exceeding the fourth threshold, at 512, the method 500 includes setting the indicator of the high-speed condition 114 to TRUE, at 518. Otherwise, the method 500 includes setting the indicator of the high-speed condition 114 to FALSE, at 516.

After setting the indicator or the high-speed condition 114 to TRUE, at 518, or to FALSE, at 516, the method 500 includes selectively performing high-speed motion compensation, at 520. For example, when the indicator of the high-speed condition has transitioned from FALSE to TRUE, indicating that high-speed travel has begun, the high-speed motion compensator 110 may initiate high-speed motion compensation by adjusting one or more of the configuration settings 116 as described in FIG. 2. As another example, when the indicator of the high-speed condition 114 has transitioned from TRUE to FALSE, indicating that high-speed travel has ended, and the high-speed motion compensator 110 may return one or more of the configuration settings 116 to a “normal” setting that is indicative of non-high-speed travel of the first end device 102. After selectively performing high-speed motion compensation, at 520, the method 500 returns to determining whether new motion data is received, at 504.

Although a particular order of decisions is illustrated in FIG. 5, in other implementations one or more of the decisions may be performed in another order or at substantially the same time (e.g., in parallel). For example, the handover rate may be compared to the second threshold prior to, or concurrently with, comparing the tracking data to the first threshold. In an implementation in which one or more components of the motion data 112 is unavailable, a corresponding portion of the method 500 related to the unavailable component is omitted.

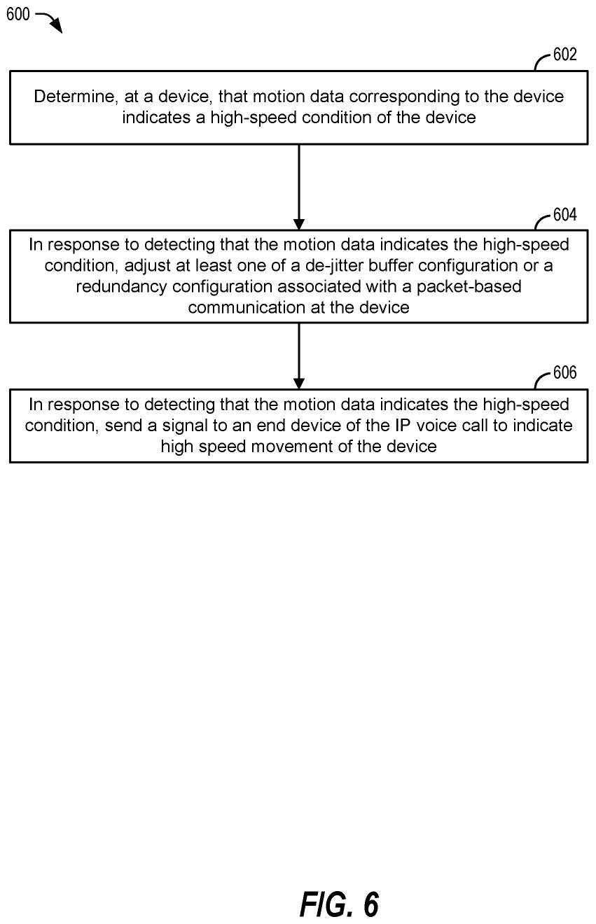

FIG. 6 depicts a particular implementation of a method 600 of compensating for high-speed travel on packet-based communication. For example, the method 600 may be performed by the first end device 102.

The method 600 includes, at 602, determining, at a device, that motion data corresponding to the device indicates a high-speed condition of the device. In an implementation, high-speed motion detector 108 determines that the motion data indicates the high-speed condition by determining that the motion data indicates a speed of the device that exceeds a threshold. In some implementations, the motion data includes at least one of the highspeed flag 230 received via a wireless network, the location-based tracking data 232 generated at the device, sensor data (e.g., the first sensor data 236, the second sensor data 238, or both) generated at the device, or a count of wireless network handovers that occur during a time interval, such as the handover rate 234.

The method 600 includes, at 604, in response to detecting that the motion data indicates the high-speed condition, adjusting at least one of a de-jitter buffer configuration or a redundancy configuration associated with a packet-based communication at the device. In an illustrative example, adjusting the de jitter buffer configuration includes increasing the depth of the de-jitter buffer 202 (e.g., the de-jitter buffer depth 240), and adjusting the redundancy configuration includes at least one of turning on redundancy for the packet-based communication (e.g., the redundancy on/off setting 242), adjusting a redundancy level of the redundancy data (e.g., the redundancy level 246), or adjusting a redundancy offset of the redundancy data (e.g., the redundancy depth 244). In some implementations, adjusting the at least one of the de-jitter buffer configuration or the redundancy configuration is performed within a mobile device.

In some implementations, the packet-based communication corresponds to an internet protocol (IP) voice call and the method 600 includes, in response to detecting that the motion data indicates the high-speed condition, sending a signal to an end device of the IP voice call to indicate high speed movement of the device, at 606. For example, in FIG. 1, the signal (e.g., the high-speed condition signal 250 of FIG. 2) is sent from the first end device 102 to the second end device 130 to indicate high-speed movement of the first end device 102.

The method 600 of FIG. 6 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 600 of FIG. 6 may be performed by a processor that executes instructions, such as described with reference to the processor 204 of FIG. 2.

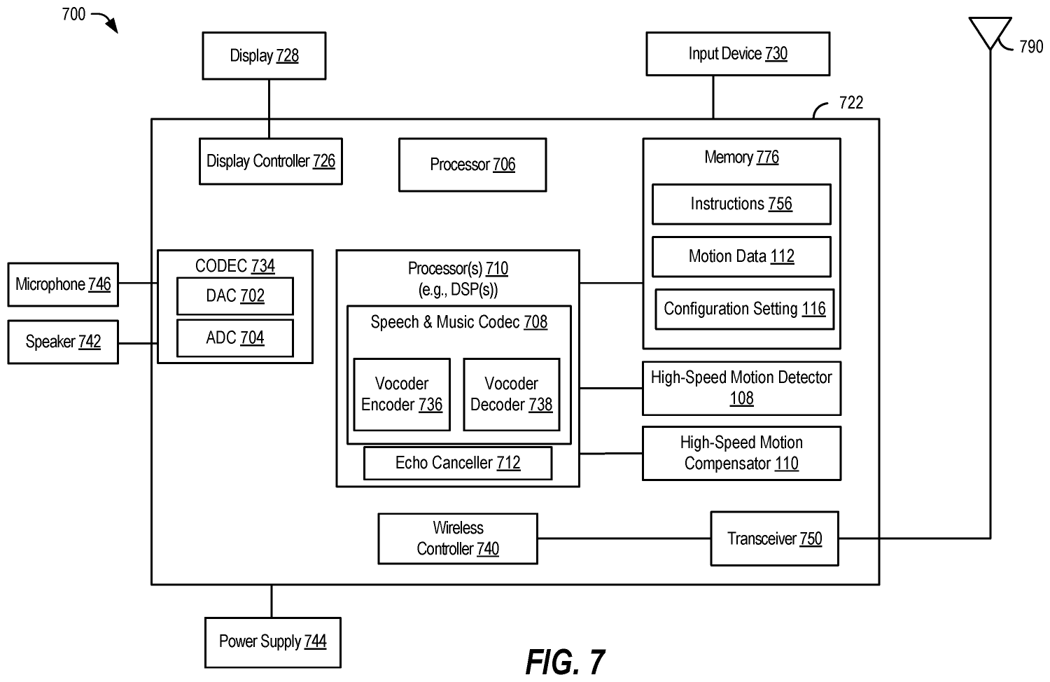

Referring to FIG. 7, a block diagram of a particular illustrative implementation of a device (e.g., a wireless communication device) is depicted and generally designated 700. In various implementations, the device 700 may have more or fewer components than illustrated in FIG. 7. In an illustrative implementation, the device 700 may correspond to the first end device 102, the second end device 130 of FIG. 1, or the device 260 of FIG. 2. In an illustrative implementation, the device 700 may perform one or more operations described with reference to FIGS. 1-6.

In a particular implementation, the device 700 includes a processor 706 (e.g., a central processing unit (CPU). The device 700 may include one or more additional processors 710 (e.g., one or more digital signal processors (DSPs)). The processors 710 may include a speech and music coder-decoder (CODEC) 708 and an echo canceller 712. The speech and music codec 708 may include a voice coder (“vocoder”) encoder 736, a vocoder decoder 738, or both.

The device 700 may include a memory 776 and a CODEC 734. The memory 776 may include the motion data 112 and the configuration setting 116. The device 700 may include a wireless controller 740 coupled, via a transceiver 750, to an antenna 790. In a particular implementation, the transceiver 750 may include the receiver 104, the transmitter 106, or both, of FIG. 1.

The device 700 may include a display 728 coupled to a display controller 726. A speaker 742 of FIG. 1, a microphone 746, or both, may be coupled to the CODEC 734. The CODEC 734 may include a digital-to-analog converter 702 and an analog-to-digital converter 704. In a particular implementation, the CODEC 734 may receive analog signals from the microphone 746, convert the analog signals to digital signals using the analog-to-digital converter 704, and provide the digital signals to the speech and music codec 708. The speech and music codec 708 may process the digital signals. In a particular implementation, the speech and music codec 708 may provide digital signals to the CODEC 734. The CODEC 734 may convert the digital signals to analog signals using the digital-to-analog converter 702 and may provide the analog signals to the speaker 742.

The device 700 may include the high-speed motion detector 108 and the high-speed motion compensator 110. In a particular implementation, the high-speed motion detector 108, the high-speed motion compensator 110, or both, may be included in the processor 706, the processors 710, the CODEC 734, the speech and music codec 708, or a combination thereof.

The high-speed motion detector 108, the high-speed motion compensator 110, or both, may be used to implement a hardware implementation of the high-speed travel compensation on packet-based communication described herein. Alternatively, or in addition, a software implementation (or combined software/hardware implementation) may be implemented. For example, the memory 776 may include instructions 756 executable by the processors 710 or other processing unit of the device 700 (e.g., the processor 706, the CODEC 734, or both). The instructions 756 may correspond to the high-speed motion detector 108, the high-speed motion compensator 110, or both.

In a particular implementation, the device 700 may be included in a system-in-package or system-on-chip device 722. In a particular implementation, the high-speed motion detector 108, the high-speed motion compensator 110, the memory 776, the processor 706, the processors 710, the display controller 726, the CODEC 734, and the wireless controller 740 are included in a system-in-package or system-on-chip device 722. In a particular implementation, an input device 730 and a power supply 744 are coupled to the system-on-chip device 722. Moreover, in a particular implementation, as illustrated in FIG. 7, the display 728, the input device 730, the speaker 742, the microphone 746, the antenna 790, and the power supply 744 are external to the system-on-chip device 722. In a particular implementation, each of the display 728, the input device 730, the speaker 742, the microphone 746, the antenna 790, and the power supply 744 may be coupled to a component of the system-on-chip device 722, such as an interface or a controller.

The device 700 may include a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, or any combination thereof.

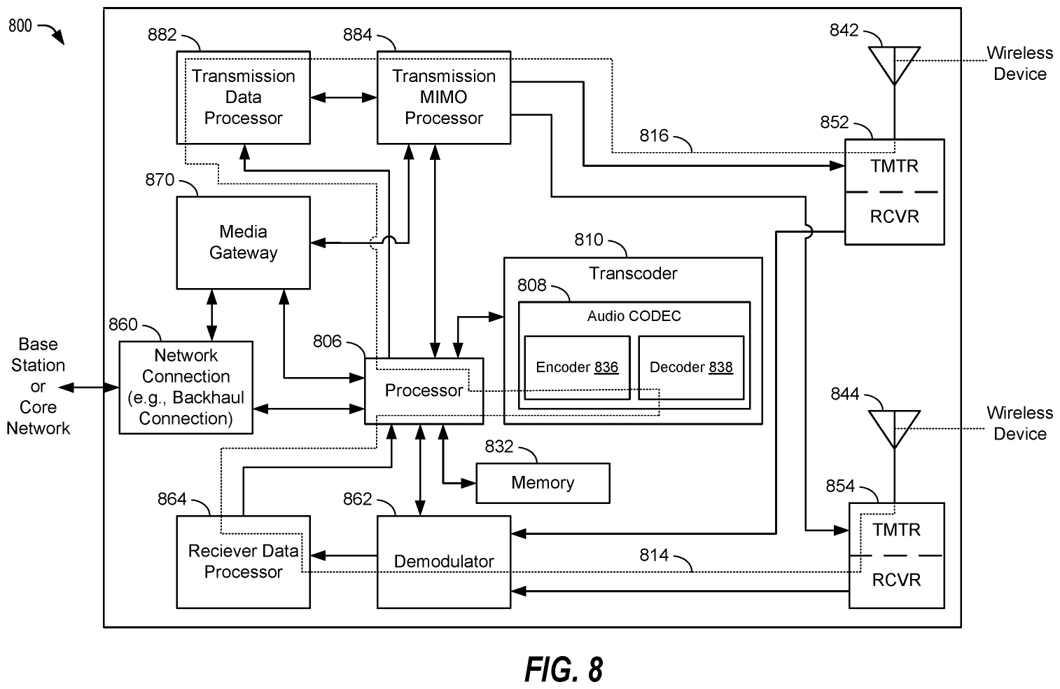

Referring to FIG. 8, a block diagram of a particular illustrative example of a base station 800 is depicted. In various implementations, the base station 800 may have more components or fewer components than illustrated in FIG. 8. In an illustrative example, the base station 800 includes the device 102 of FIG. 1. In another illustrative example, the base station 800 includes the base station 146 of FIG. 1. In an illustrative example, the base station 800 may operate according to the techniques described with reference to FIGS. 1-7.

The base station 800 may be part of a wireless communication system. The wireless communication system may include multiple base stations and multiple wireless devices. The wireless communication system may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA.

The wireless device may also be referred to as user equipment (UE), a mobile station, a terminal, an access terminal, a subscriber unit, a station, etc. The wireless device may include a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. The wireless device may include or correspond to the device 700 of FIG. 7.

Various functions may be performed by one or more components of the base station 800 (and/or in other components not shown), such as sending and receiving messages and data (e.g., audio data). In a particular example, the base station 800 includes a processor 806 (e.g., a CPU). The base station 800 includes a transcoder 810. The transcoder 810 includes an audio CODEC 808. For example, the transcoder 810 may include one or more components (e.g., circuitry) configured to perform operations of the audio CODEC 808. As another example, the transcoder 810 is configured to execute one or more computer-readable instructions to perform the operations of the audio CODEC 808. Although the audio CODEC 808 is illustrated as a component of the transcoder 810, in other examples one or more components of the audio CODEC 808 may be included in the processor 806. For example, a decoder 838 (e.g., a vocoder decoder) may be included in a receiver data processor 864. As another example, an encoder 836 (e.g., a vocoder encoder) may be included in a transmission data processor 882. The audio CODEC 808 includes the encoder 836 and the decoder 838. The decoder 838 includes the speech decoder 156 of FIG. 1.

The transcoder 810 may function to transcode messages and data between two or more networks. The transcoder 810 may be configured to convert message and audio data from a first format (e.g., a digital format) to a second format. To illustrate, the decoder 838 may decode encoded signals having a first format and the encoder 836 may encode the decoded signals into encoded signals having a second format. Additionally or alternatively, the transcoder 810 may be configured to perform data rate adaptation. For example, the transcoder 810 may down-convert a data rate or up-convert the data rate without changing a format of the audio data. To illustrate, the transcoder 810 may down-convert 64 kbit/s signals into 16 kbit/s signals.

The base station 800 includes a memory 832, such as a computer-readable storage device, that includes instructions. The instructions may include one or more instructions that are executable by the processor 806, the transcoder 810, or a combination thereof, to perform one or more operations described with reference to the methods and systems of FIGS. 1-7. For example, the instructions may cause the processor 806 to perform operations including determining high-speed motion of an end device of a packet-based communication (e.g., by receiving the high-speed condition signal 250 via a second antenna 844) and adjusting the depth of a de-jitter buffer used in the transcoder 810, adjusting a redundancy setting applied in the transcoder 810, or a combination thereof. As another example, the instructions may cause the processor 806 to perform operations including determining high-speed motion of the base station 800 (e.g., by generating the motion data 112 based on motion sensors of the base station 800) and adjusting the depth of a de-jitter buffer used in the transcoder 810, adjusting a redundancy setting applied in the transcoder 810, or a combination thereof. The base station 800 may include multiple transmitters and receivers (e.g., transceivers), such as a first transceiver 852 and a second transceiver 854, coupled to an array of antennas. The array of antennas includes a first antenna 842 and the second antenna 844. The array of antennas may be configured to wirelessly communicate with one or more wireless devices, such as the first end device 102, the second end device 130, the device 260, or the device 700 of FIG. 7. For example, the second antenna 844 may receive a data stream 814 (e.g., a bit stream) from a wireless device. The data stream 814 may include messages, data (e.g., encoded speech data), or a combination thereof.

The base station 800 includes a network connection 860, such as a backhaul connection. The network connection 860 may be configured to communicate with a core network or one or more base stations of the wireless communication network. For example, the base station 800 may receive a second data stream (e.g., messages or audio data) from a core network via the network connection 860. The base station 800 may process the second data stream to generate messages or audio data and provide the messages or the audio data to one or more wireless devices via one or more antennas of the array of antennas or to another base station via the network connection 860. In a particular implementation, the network connection 860 may be a wide area network (WAN) connection, as an illustrative, non-limiting example. In some implementations, the core network may include or correspond to a packet backbone network.

The base station 800 includes a media gateway 870 that is coupled to the network connection 860 and the processor 806. The media gateway 870 may be configured to convert between media streams of different telecommunications technologies. For example, the media gateway 870 may convert between different transmission protocols, different coding schemes, or both. To illustrate, the media gateway 870 may convert from PCM signals to Real-Time Transport Protocol (RTP) signals, as an illustrative, non-limiting example. The media gateway 870 may convert data between packet switched networks (e.g., a Voice Over Internet Protocol (VoIP) network, an IP Multimedia Subsystem (IMS), a fourth generation (4G) wireless network, such as LTE, WiMax, and UMB, etc.), circuit switched networks, and hybrid networks (e.g., a second generation (2G) wireless network, such as GSM, GPRS, and EDGE, a third generation (3G) wireless network, such as WCDMA, EV-DO, and HSPA, etc.).

Additionally, the media gateway 870 includes a transcoder and may be configured to transcode data when codecs are incompatible. For example, the media gateway 870 may transcode between an Adaptive Multi-Rate (AMR) codec and a G.711 codec, as an illustrative, non-limiting example. The media gateway 870 may include a router and a plurality of physical interfaces. In some implementations, the media gateway 870 may also include a controller (not shown). In a particular implementation, the media gateway controller may be external to the media gateway 870, external to the base station 800, or both. The media gateway controller may control and coordinate operations of multiple media gateways. The media gateway 870 may receive control signals from the media gateway controller and may function to bridge between different transmission technologies and may add service to end-user capabilities and connections.

The base station 800 includes a demodulator 862 that is coupled to the transceivers 852, 854, the receiver data processor 864, and the processor 806, and the receiver data processor 864 may be coupled to the processor 806. The demodulator 862 may be configured to demodulate modulated signals received from the transceivers 852, 854 and to provide demodulated data to the receiver data processor 864. The receiver data processor 864 may be configured to extract a message or audio data from the demodulated data and send the message or the audio data to the processor 806.

The base station 800 includes a transmission data processor 882 and a transmission multiple input-multiple output (MIMO) processor 884. The transmission data processor 882 may be coupled to the processor 806 and the transmission MIMO processor 884. The transmission MIMO processor 884 may be coupled to the transceivers 852, 854 and the processor 806. In some implementations, the transmission MIMO processor 884 may be coupled to the media gateway 870. The transmission data processor 882 may be configured to receive the messages or the audio data from the processor 806 and to code the messages or the audio data based on a coding scheme, such as CDMA or orthogonal frequency-division multiplexing (OFDM), as an illustrative, non-limiting examples. The transmission data processor 882 may provide the coded data to the transmission MIMO processor 884.

The coded data may be multiplexed with other data, such as pilot data, using CDMA or OFDM techniques to generate multiplexed data. The multiplexed data may then be modulated (i.e., symbol mapped) by the transmission data processor 882 based on a particular modulation scheme (e.g., Binary phase-shift keying (“BPSK”), Quadrature phase-shift keying (“QSPK”), M-ary phase-shift keying (“M-PSK”), M-ary Quadrature amplitude modulation (“M-QAM”), etc.) to generate modulation symbols. In a particular implementation, the coded data and other data may be modulated using different modulation schemes. The data rate, coding, and modulation for each data stream may be determined by instructions executed by the processor 806.

The transmission MIMO processor 884 may be configured to receive the modulation symbols from the transmission data processor 882 and may further process the modulation symbols and may perform beamforming on the data. For example, the transmission MIMO processor 884 may apply beamforming weights to the modulation symbols. The beamforming weights may correspond to one or more antennas of the array of antennas from which the modulation symbols are transmitted.

During operation, the second antenna 844 of the base station 800 may receive a data stream 814. The second transceiver 854 may receive the data stream 814 from the second antenna 844 and may provide the data stream 814 to the demodulator 862. The demodulator 862 may demodulate modulated signals of the data stream 814 and provide demodulated data to the receiver data processor 864. The receiver data processor 864 may extract audio data from the demodulated data and provide the extracted audio data to the processor 806.

The processor 806 may provide the audio data to the transcoder 810 for transcoding. The decoder 838 of the transcoder 810 may decode the audio data from a first format into decoded audio data, and the encoder 836 may encode the decoded audio data into a second format. In some implementations, the encoder 836 may encode the audio data using a higher data rate (e.g., up-convert) or a lower data rate (e.g., down-convert) than received from the wireless device. In other implementations, the audio data may not be transcoded. Although transcoding (e.g., decoding and encoding) is illustrated as being performed by a transcoder 810, the transcoding operations (e.g., decoding and encoding) may be performed by multiple components of the base station 800. For example, decoding may be performed by the receiver data processor 864 and encoding may be performed by the transmission data processor 882. In other implementations, the processor 806 may provide the audio data to the media gateway 870 for conversion to another transmission protocol, coding scheme, or both. The media gateway 870 may provide the converted data to another base station or core network via the network connection 860.

The transcoded audio data from the transcoder 810 may be provided to the transmission data processor 882 for coding according to a modulation scheme, such as OFDM, to generate the modulation symbols. The transmission data processor 882 may provide the modulation symbols to the transmission MIMO processor 884 for further processing and beamforming. The transmission MIMO processor 884 may apply beamforming weights to the modulation symbols and provide the resulting signals to one or more antennas of the array of antennas, such as the first antenna 842 via the first transceiver 852. Thus, the base station 800 may provide a transcoded data stream 816, that corresponds to the data stream 814 received from the wireless device, to another wireless device. The transcoded data stream 816 may have a different encoding format, data rate, or both, than the data stream 814. In other implementations, the transcoded data stream 816 may be provided to the network connection 860 for transmission to another base station or a core network.

In conjunction with the described implementations, an apparatus includes means for wirelessly receiving packets associated with a packet-based communication. In some examples, the means for wirelessly receiving packets associated with a packet-based communication includes the receiver 104, the antenna 207, the decoder 225, the antenna 287, the receiver 262, the decoder 267, the antenna 790, the transceiver 750, the wireless controller 740, the processor 706, the processor(s) 710, the CODEC 734, the antenna 844, the transceiver 854, the demodulator 862, the receiver data processor 864, the transcoder 810, the processor 806, one or other circuits or devices configured to wirelessly receive packets associated with a packet-based communication, or a combination thereof.

The apparatus also includes means for determining whether motion data corresponding to an end device of the packet-based communication indicates a high-speed condition of the end device. In some examples, the means for determining whether motion data corresponding to an end device of the packet-based communication indicates a high-speed condition of the end device includes the high-speed motion detector 108, the processor 204, the accelerometer 254, the gyroscope 256, the comparator 222, the high-speed motion detector 272, the processor 276, the processor 706, the processor(s) 710, the processor 804, one or other circuits or devices configured to determine whether motion data corresponding to an end device of the packet-based communication indicates a high-speed condition of the end device, or a combination thereof.

The apparatus also includes means for adjusting a configuration setting associated with the packet-based communication in response to the motion data indicating the high-speed condition. In some examples, the means for adjusting a configuration setting associated with the packet-based communication in response to the motion data indicating the high-speed condition includes the high-speed motion compensator 110, the processor 204, the high-speed motion compensator 274, the processor 276, the processor 706, the processor(s) 710, the processor 804, one or other circuits or devices configured to adjust a configuration setting associated with the packet-based communication in response to the motion data indicating the high-speed condition, or a combination thereof.

In some implementations, the apparatus includes means for storing the packets, and the means for adjusting is configured to adjust the means for storing in response to the motion data indicating the high-speed condition. In some examples, the means for storing the packets includes the de jitter buffer 202, the memory 206, the de jitter buffer 268, the memory 278, the memory 776, the memory 832, one or more other circuits or devices configured to store packets, or a combination thereof.

In some implementations, the apparatus includes means for generating outgoing packets associated with the packet-based communication. In some examples, the means for generating outgoing packets associated with the packet-based communication includes the encoder 223, the encoder 266, the processor 204, the processor 276, the processor 706, the processor(s) 710, the codec 708, the wireless controller 740, the processor 806, the transmission data processor 882, the transmission MIMO processor 884, one or more other circuits or devices configured to generate outgoing packets, or a combination thereof.

In some implementations, the apparatus includes means for wirelessly sending the outgoing packets. In some examples, the means for wirelessly sending the outgoing packets includes the transmitter 106, the antenna 207, the encoder 223, the antenna 287, the transmitter 264, the encoder 266, the wireless controller 740, the transceiver 750, the antenna 790, the transmission data processor 882, the transmission MIMO processor 884, the transceiver 852, the antenna 842, one or more other circuits or devices configured to wirelessly send outgoing packets, or a combination thereof.

In some implementations, the apparatus includes means for selectively generating redundancy data associated with the outgoing packets, where the configuration setting includes a redundancy setting, and where adjusting the configuration setting includes changing the redundancy setting to cause the means for selectively generating redundancy data to at least one of initiate generating the redundancy data, increase a redundancy level of the redundancy data, or decrease a redundancy offset of the redundancy data. In some examples, the means for selectively generating redundancy data includes redundancy manager 226, the processor 204, the redundancy manager 270, the processor 276, the processor 706, the processor(s) 710, the wireless controller 740, the processor 806, the transcoder 810, the transmission data processor 882, the transmission MIMO processor 884, one or more circuits or devices configured to selectively generating redundancy data associated with the outgoing packets, or a combination thereof.

In some implementations, the apparatus includes means for generating at least part of the motion data. In some examples, the means for generating at least part of the motion data includes location-based tracking engine 258, the accelerometer 254, the gyroscope 256, the processor 204, the processor 276, the processor 706, the processor(s) 710, processor 806, one or more other circuits or devices configured to generate at least part of the motion data, or a combination thereof.

In some implementations, a non-transitory computer-readable medium includes instructions that, when executed by a processor, cause the processor to perform operations. In some examples, instructions in the memory 206 are executable by the processor 204, instructions in the memory 278 are executable by the processor 276, the instructions 756 in the memory 776 are executable by the processor 706, the processor(s) 710, or a combination thereof. The instructions include determining, at a device, that motion data corresponding to the device indicates a high-speed condition of the device. The instructions also include, in response to detecting that the motion data indicates the high-speed condition, adjusting at least one of a de-jitter buffer configuration or a redundancy configuration associated with a packet-based communication at the device. In an illustrative example, the packet-based communication corresponds to an internet protocol (IP) voice call, and the motion data indicates that a speed of the device exceeds a threshold.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein and is to be accorded the widest scope possible consistent with the principles and novel features as defined by the following claims.

What is claimed is:

1. A device comprising:
a receiver configured to wirelessly receive packets associated with a packet-based communication;
a high-speed motion detector configured to determine whether motion data corresponding to an end device of the packet-based communication indicates a high-speed condition of the end device; and
a high-speed motion compensator configured to adjust a configuration setting associated with the packet-based communication in response to the motion data indicating the high-speed condition.

2. The device of claim 1, further comprising a de-jitter buffer configured to store packets of the packet-based communication, wherein the configuration setting includes a depth of the de-jitter buffer, and wherein the high-speed motion compensator is configured to increase the depth of the de-jitter buffer in response to the motion data indicating the high-speed condition.

3. The device of claim 2, wherein the high-speed condition is indicative of high-speed travel of the end device that results in increased packet jitter due to an increased rate of wireless network handover events at the end device, and wherein increasing the depth of the de jitter buffer improves a quality of the packet-based communication by reducing a number of delayed packets that are not received in the de-jitter buffer in sufficient time for playback.

4. The device of claim 1, further comprising:
an encoder configured to generate outgoing packets associated with the packet-based communication; and
a transmitter configured to wirelessly transmit the outgoing packets.

5. The device of claim 4, further comprising a redundancy manager configured to selectively generate redundancy data associated with one or more of the outgoing packets, wherein the configuration setting includes a redundancy setting, and wherein adjusting the configuration setting includes changing the redundancy setting to cause the redundancy manager to at least one of:
initiate generating the redundancy data,
increase a redundancy level of the redundancy data, or
decrease a redundancy depth of the redundancy data.

6. The device of claim 5, wherein the redundancy manager is configured to increase the redundancy level by increasing a proportion of the outgoing packets that include redundancy data and to decrease the redundancy depth by reducing a number of the outgoing packets that are between a particular packet and redundancy data for the particular packet.

7. The device of claim 5, wherein the high-speed condition is indicative of high-speed travel of the end device that results in an increased number of packets that are lost or corrupted due to an increased rate of wireless network handover events at the end device.

8. The device of claim 4, wherein the high-speed motion compensator is configured to transmit a signal that indicates the high-speed condition.

9. The device of claim 8, wherein transmitting the signal enables the end device or a base station to at least one of:
increase a depth of a second de jitter buffer at the end device or at the base station;
initiate generating redundancy data associated with the packets;
increase a redundancy level of the redundancy data generated for the packets by increasing a proportion of the packets that include the redundancy data; or
decrease a redundancy depth of the redundancy data generated for the packets by reducing a number of packets that are between a first packet and first redundancy data for the first packet.

10. The device of claim 1, wherein the motion data includes a highspeed flag, and wherein the receiver is configured to receive the highspeed flag via a wireless network.

11. The device of claim 10, wherein the receiver is configured to receive the highspeed flag in a system information block-2 (SIB2) message from a base station of the wireless network to provide radio resource configuration information associated with the wireless network.

12. The device of claim 1, wherein the motion data includes location-based tracking data, and further comprising a location engine configured to perform location-based tracking to generate the location-based tracking data.

13. The device of claim 1, wherein the motion data includes motion sensor data, and further comprising a motion sensor configured to generate the motion sensor data.

14. The device of claim 1, further comprising:
an antenna coupled to the receiver and configured to receive the packets.

15. The device of claim 14, wherein the receiver, the high-speed motion detector,
the high-speed motion compensator, and the antenna are integrated into a mobile device.

16. A method comprising:
determining, at a device, that motion data corresponding to the device indicates a high-speed condition of the device; and
in response to detecting that the motion data indicates the high-speed condition, adjusting at least one of a de-jitter buffer configuration or a redundancy configuration associated with a packet-based communication at the device.

17. The method of claim 16, wherein the packet-based communication corresponds to an internet protocol (IP) voice call.

18. The method of claim 17, further comprising, in response to detecting that the motion data indicates the high-speed condition, sending a signal to an end device of the IP voice call to indicate high speed movement of the device.

19. The method of claim 16, wherein the motion data indicates that a speed of the device exceeds a threshold.

20. The method of claim 16, wherein the motion data includes at least one of:
a highspeed flag received via a wireless network,
location-based tracking data generated at the device,
sensor data generated at the device, or
a count of wireless network handovers that occur during a time interval.

21. The method of claim 16, wherein adjusting the de jitter buffer configuration includes increasing a depth of a de jitter buffer and wherein adjusting the redundancy configuration includes at least one of turning on redundancy for the packet-based communication, adjusting a redundancy level of redundancy data, or a redundancy offset of the redundancy data.

22. The method of claim 16, wherein adjusting the at least one of the de-jitter buffer configuration or the redundancy configuration is performed within a mobile device.

23. An apparatus comprising:
means for wirelessly receiving packets associated with a packet-based communication;
means for determining whether motion data corresponding to an end device of the packet-based communication indicates a high-speed condition of the end device; and
means for adjusting a configuration setting associated with the packet-based communication in response to the motion data indicating the high-speed condition.

24. The apparatus of claim 23, further comprising means for storing the packets, and wherein the means for adjusting is configured to adjust the means for storing in response to the motion data indicating the high-speed condition.

25. The apparatus of claim 23, further comprising:
means for generating outgoing packets associated with the packet-based communication; and
means for wirelessly sending the outgoing packets.

26. The apparatus of claim 25, further comprising means for selectively generating redundancy data associated with the outgoing packets, wherein the configuration setting includes a redundancy setting, and wherein adjusting the configuration setting includes changing the redundancy setting to cause the means for selectively generating redundancy data to at least one of:
initiate generating the redundancy data,
increase a redundancy level of the redundancy data, or
decrease a redundancy offset of the redundancy data.

27. The apparatus of claim 23, further comprising means for generating at least part of the motion data.

28. A non-transitory computer-readable medium comprising instructions that, when executed by a processor, cause the processor to perform operations comprising:
determining, at a device, that motion data corresponding to the device indicates a high-speed condition of the device; and
in response to detecting that the motion data indicates the high-speed condition, adjusting at least one of a de-jitter buffer configuration or a redundancy configuration associated with a packet-based communication at the device.

29. The non-transitory computer-readable medium of claim 28, wherein the packet-based communication corresponds to an internet protocol (IP) voice call.

30. The non-transitory computer-readable medium of claim 29, wherein the motion data indicates that a speed of the device exceeds a threshold.
